(19) United States
(12) Patent Application Publication
(10) Pub. No.: US 2016/0318347 A1
(43) Pub. Date: Nov. 3, 2016

(54) EVOLVING TIRE TREAD

(71) Applicants: COMPAGNE GENERALE DES ETABLISSEMENTS MICHELIN, Clermont-Ferrand (FR); MICHELIN RECHERCHE ET TECHNIQUE S.A., Granges-Paccot (CH)

(72) Inventors: Damien BARDIN, Clermont-Ferrand (FR); Stephanie CAMBON, Clermont-Ferrand (FR)

(73) Assignees: COMPAGNE GENERALE DES ETABLISSEMENTS MICHELIN, Clermont-Ferrand (FR); MICHELIN RECHERCHE ET TECHNIQUE S.A., Granges-Paccot (CH)

(21) Appl. No.: 15/104,153

(22) PCT Filed: Dec. 9, 2014
(86) PCT No.: PCT/EP2014/077090

§ 371 Date: Jun. 13, 2016

(30) Foreign Application Priority Data
Dec. 13, 2013 (FR) 1362636

(51) Int. Cl. B60C 11/03; B60C 11/13

(52) U.S. Cl. CPC B60C 11/0323; B60C 11/1307; B60C 2200/06; B60C 2011/1338

(57) ABSTRACT

A tread for a heavy vehicle tire having a total thickness PMU corresponding to the thickness of material to be worn away during running is provided herein. This tread has a tread surface that comes into contact with a roadway when a tire provided with this tread is being driven on, this tread includes at least one cut opening in the initial condition onto the tread surface when new.

### CROSS REFERENCE TO RELATED APPLICATIONS

This application is a 371 national phase entry of PCT/EP2014/077090, filed 9 Dec. 2014, which claims the benefit of French Patent Application No. 1362636, filed 13 Dec. 2013, the contents of which are incorporated herein by reference for all to purposes.

### BACKGROUND

The invention relates to treads for tires and more particularly to the designs of the tread pattern for these treads and to the tires provided with such treads which have a lasting ability to drain away standing water present on the roadway in times of wet weather, these treads having improved running performance.

As is known, wet weather driving conditions require the most rapid possible elimination of the water between the tread of each tire and the roadway so as to ensure that the tread makes contact with the roadway. Water that is not pushed over the front of the tire slows partially along the grooves and sipes formed in the tire tread, whether these grooves and sues be oriented in the circumferential direction or the transverse direction or even an oblique direction.

A cut refers to any cavity created in a tread by molding, this cut extending in a main direction and into the depth of the tread.

A groove here means a void that opens onto a tread surface intended to be in contact with the roadway, this void having a mean width such that the walls of material delimiting it are never in contact with one another under the normal service conditions of the tire.

A sips here means a thin slit having a mean width that is small and such that, under normal tire service conditions, the walls of material delimiting it may at least partially come into contact with one another when that sipe is in the contact patch in which the tire is in contact with the roadway.

The thickness of material to be worn away (denoted PMU) refers to the thickness of tread that can be worn away during running before the legal tread wear limit notably identified by wear indicators formed in the grooves is reached.

in the present description, the terms radial or radially are used to indicate a direction which, when considered on the tire, is a direction perpendicular to the axis of rotation of the tire whereas, when considered on a tread alone, it corresponds to the direction of the thickness of the said tread. Moreover, the term circumferential is used to indicate a direction which corresponds to a direction tangential to any circle centered on the axis of rotation of the tire. This same direction corresponds to the longitudinal direction of the tread, the latter being formed in the manner of a flat strip before it is incorporated at the time of manufacture of a tire.

Whatever the category of tire (namely whether it be a tire to be fitted to a passenger vehicle or to a vehicle intended to carry heavy loads), the tread needs to have standing-water drainage performance that always remains above a minimum performance referred to as the safe performance. Accordingly, and given that the tread gradually wears away, progressively reducing the cross sections of the grooves and therefore the ability of these grooves to remove a volume of liquid, it is commonplace to produce grooves that open onto the tread surface when new and that extend into the thickness of the tread down to at least a level that corresponds to a legal limit that requires the tread to be withdrawn.

The disadvantage of creating a plurality of grooves in a tread is that it reduces the amount of tread material for a given width of tread and therefore has an appreciable impact on the stiffness of the tread. As a result, in order to address the loadings experienced by the tread during running, those skilled in the art need to compensate for these reductions in stiffness by any means at their disposal, and notably by adapting the internal structure of the tire, something that is, of course, not without its own impact on the cost price of the tire itself. These reductions in stiffness may also adversely affect the wear rate, the evenness of this wear, and some of the expected aspects of performance during running.

Moreover, it is found that there is an increase in rolling resistance, which manifests itself in an appreciable increase in fuel consumption of vehicles fitted with such tires, as a result of an increase in hysteresis losses associated with the cycles of deformation of the rubbery material of which the tread is made.

Document WO 2011-039194 A1 has proposed forming in a tread grooves that have the particular feature of opening discontinuously onto the tread surface when new. This groove can be considered to be a groove that is wavy in the thickness of the tread opening regularly onto the tread surface. This type of wavy groove can be formed whether in the circumferential direction or in any other direction. As described in that publication, this type of groove is initially (which corresponds to the tread being in the as-new condition) continuous so that when driving on a roadway covered in standing water, water can be picked up in those parts of the groove that open onto the tread surface as they enter the contact patch, the water thus picked up being drained along the wavy groove beneath the tread surface. The liquid thus picked up is then ejected outside of the contact patch under the effect of centrifugal forces. That same document describes the possibility, after the manner of tread pattern designs of the prior art, of making connections between at least two wavy grooves of this type. This type of embodiment performs very well but requires suitable molding technology.

### SUMMARY

The present invention seeks to propose a new cut geometry without needing to change the molding technology, this cut providing both excellent drainage of the water picked up in the contact patch, so as to make the necessary contact with the roadway while at the same time limiting the reduction in stiffness of the tread in order notably to reduce the hysteresis losses associated with the deformations of the tread pattern elements of the tread when they are in the contact patch.

The object of the invention is to provide a tread provided with cuts that make it possible to obtain performance that is equal or superior to the minimum safety performance in terms of water drainage, irrespective of the level of tread wear, while at the same time obtaining performance in terms of rolling resistance that meets the present-day requirements of the heavy vehicle tire market.

To this end, one subject of the invention is a tread for a heavy vehicle tire having a total thickness PMU corresponding to the thickness of material to be worn away during running. This thickness PMU is usually identified by tread wear indicators present in the bottoms of the cuts. This tread has a tread surface intended to come into contact with a roadway when a tire provided with this tread is being driven on. This tread surface evolves with wear from an as-new tread surface.

This tread comprises at least one cut opening in the initial condition (when the tread is new and unworn) onto the tread surface when new, this cut being characterized in that it comprises several parts joined together and namely:
an external part, which means to say one opening onto the tread surface when new, this external part forming a groove having a mean depth Pe at most equal to 90% of the thickness PMU;
this external part having a minimum width Lm measured on the tread surface when new;
an internal part forming the bottom of the cut, this internal part having the shape of a channel of mean height Hc, this channel being intended to form a new groove when the part wear of the tread reaches at most 90% of the thickness PMU;
this channel forming the bottom of the cut and comprising at least one narrow part of maximum width Le and at least one wider part of maximum width LE, each widened part (221) of the channel extending into the groove of the external part of the cut in the form of a widening of the groove, this widening having a maximum width LM at least equal to the maximum width LE of the widened part of the channel.

For preference, the channel forming the internal part of the cut has a minimum width Le which is at least equal to 20% of the minimum width Lm of the groove of the external part measured on the tread surface when new.

For preference, the mean height Hc of the channel is at most equal to 75% of the thickness PMU.

For preference, each widened part of the channel has a maximum width LE at least equal to 1.2 times the minimum width Le of the same channel and, more preferably still, at least equal to 1.3 times the minimum width Le.

For preference, the mean depth Pe of the external part is at most equal to 50% of the thickness PMU.

By virtue of this tread structure, a void volume is obtained that is suited to achieving satisfactory drainage when new and regardless of the level of wear while at the same time limiting the reduction in tread stiffness when new.

To make it easier for liquid to flow along inside the cut according to the invention it is sensible to ensure that the connections between the various parts of the cut are made without any sharp discontinuities in geometry. The use of suitable blend radii is beneficial.

For preference, the volume of each widening of the groove is at least equal to the volume of each widened part of the channel.

In order to limit still further the reduction in stiffness of the tread provided with at least one cut according to the invention, it is sensible to ensure that the groove closes up at least partially when it enters the contact patch during running. Closes up at least partially should be understood here as meaning that, with the exception of the widenings, the groove at least in its innermost region is closed, which amounts to stating that this groove has opposing wails that come into contact with one another. By virtue of the presence of the widenings it is still possible for water present on the roadway in times of wet weather to be drained away towards the inside of the channel.

The invention also relates to a tire provided with a tread defined in accordance with the invention, this tread surmounting radially on the outside a tire casing made up of a carcass reinforcement and of a crown reinforcement. The tread of this tire is created in accordance with one of the alternative forms of embodiment described hereinabove, certain dimensions being connected with the mean length of the area of contact of the tread with the roadway under the nominal service conditions of the tire, these nominal service conditions being defined in the regulations of the E.T.R.T.O. or of the J.A.T.M.A. or even of the T.R.A. That may notably be the case in respect of the lengths of the widenings of the external groove and of the widened parts of the channel. Specifically, it is sensible for there always to be at least one widening in the contact patch in order to satisfactorily drain away any water that may potentially be present on the roadway.

Further features and advantages of the invention will become apparent from the description given hereinafter with reference to the attached drawings which, by way of nonlimiting example, show one embodiment of the subject matter of the invention.

### BRIEF DESCRIPTION OF THE FIGURES

FIG. 1 shows a partial view of a cut according to the invention in a tread;

FIGS. 2A and 2B show cross sections on two planes perpendicular to the plane of FIG. 1 and the respective lines of which are indicated by the lines IIA-IIA and IIB-IIB.

### DETAILED DESCRIPTION

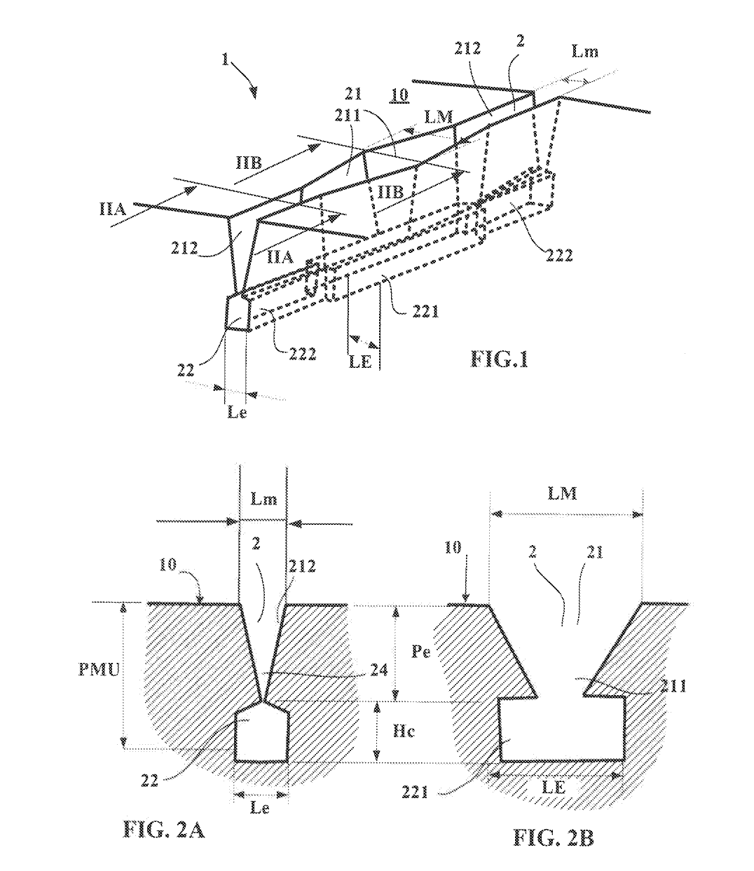

FIG. 1 shows a partial view of a cut according to the invention in a tread intended to be fitted to a heavy vehicle tire of size 315/70R22.5.

This tread 1 comprises, when new—as depicted in FIG. 1—a tread surface 10 intended to come into contact with a roadway during running.

Opening onto this tread surface 10 is a cut 2 oriented in a main direction. This cut 2 extends into the thickness of the tread down to a depth greater than the maximum thickness PMU of material to be worn away during running. This maximum thickness PMU is equal in this case instance to 14.5 mm. In this figure it may be seen that the total depth of the groove is greater than the thickness PMU of material to be worn away, so that good performance is maintained, notably in terms of the drainage of water in times of wet weather, down to a degree of wear corresponding to that depth.

The cut 2 comprises on its external part, namely radially towards the outside, a groove 21 the section of which varies in its main orientation. This groove 21 has a depth equal to 10.4 mm, namely 72% of the maximum thickness PMU of material to be worn away during running.

This groove 21 is extended radially on the inside by a channel 22 that is continuous in the main direction of the cut and has a height Hc equal to 4.1 mm. This channel 22 comprises a plurality of widened parts 221 of width LE equal to 7.1 mm and a plurality of narrow parts 222 of width Le equal to 4.1 mm, the widened parts and the narrow parts of the channel being arranged so that they alternate in the main direction of the cut.

Each widened part 221 of the channel 22 is extended radially towards the outside of the tread by a widening 211 constituting part of the groove 21. The maximum width LM measured on the tread surface 10 when new of this widening 211 is equal here to 7.1 mm. Between two widenings 211 of the groove there are groove parts 212 of mean width Lm equal to 5 mm on the tread surface when new.

Furthermore, in these narrowest groove parts 212 it may be noted that the bottom of the groove is such that the walls delimiting the said sipe are inclined with respect to one another in a manner suited to allowing them locally at least to come to press against one another in the contact patch (the bottom is extended radially towards the inside by the channel 22). Thanks to this pressing-together it is possible to limit the loss of stiffness of a tread provided with at least one cut while at the same time ensuring correct drainage of the liquids present on the roadway.

By virtue of this design of cut, it is possible when new to meet the specifications of a heavy vehicle tire in terms of the required performance for driving on a roadway covered with standing water.

FIGS. 2A and 2B show cross sections on two planes perpendicular to the plane of FIG. 1 and the respective lines of which are indicated by the lines IIA-IIA and IIB-IIB. These cross sections show the cut in an unstressed configuration, which means to say in an unloaded state. It will be appreciated notably from these two figures that the external part of the groove can close up as the groove enters the contact patch given the short distance between the opposing walls whereas in the widened regions there is—even when these are in the contact patch—an opening between the external part and the internal part forming a channel.

That which has been shown and described in relation to a cut in a single orientation may easily be applied to the case of a cut oriented circumferentially or in any oblique direction on a tire. Likewise, this cut may follow an overall direction that is wavy or even that zig-zags.

The invention is not restricted to the examples described and various modifications can be made thereto without departing from its scope as defined in the claims.

1. A tread for a heavy vehicle tire having a total thickness PMU, the PMU being defined as a thickness of material to worn away during running of the heavy vehicle tire, comprising:
a tread surface intended to come into contact with a roadway when a tire provided with this tread is being driven on;
at least one cut opening in the initial condition onto the tread surface when new, the cut including several parts joined together and namely;
an external part opening onto the tread surface when new, the external part forming a groove having a mean depth Pe at most equal to 90% of the thickness PMU,
the external part having a minimum width Lm measured on the tread surface when new;
an internal part forming the bottom of the cut, the internal part having the shape of a channel of mean height Hc, the channel being formed on a new groove when the tread becomes part-worn;
wherein the channel forming the bottom of the cut comprises:
at least one narrow part of maximum width Le and at least one wider part of maximum width LE, each widened part of the channel extending into the groove of the external part of the cut in the form of a widening of the groove, the widening having a maximum width LM, measured on the tread surface when new, at least equal to the maximum width LE of the widened part of the channel.

2. The tread according to claim 1, wherein the channel forming the internal part of the cut has a minimum width Le which is at least equal to 20% of the minimum width Lin of the groove of the external part measured on the tread surface when new.

3. The tread according to claim 1, wherein the mean height Hc of the channel is at most equal to 7.5 of the thickness PMU.

4. The tread according to claim 1, wherein each widened part of the channel has a maximum width LE at least equal to 1.2 times the minimum width Le of the same channel and, more preferably still, at least equal to 1.3 times the minimum width Le.

5. The tread according to claim 1, wherein the heavy vehicle tire associated with the tread is shaped to be fitted to a heavy vehicle.
